(19) United States
(12) Patent Application Publication
(10) Pub. No.: US 2009/0009651 A1
(43) Pub. Date: Jan. 8, 2009

(54) Imaging Apparatus And Automatic Focus Control Method

(75) Inventor: Wataru TAKAYANAGI, Ashiya City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi City (JP)

(21) Appl. No.: 12/167,585

(22) Filed: Jul. 3, 2008

(30) Foreign Application Priority Data
Jul. 4, 2007 (JP) JP2007-176100
May 28, 2008 (JP) JP2008-139319

(51) Int. Cl. H04N 5/232; G03B 13/36

(52) U.S. Cl. 348/345; 396/89; 396/133; 348/E05.042

(57) ABSTRACT

An imaging apparatus includes an imaging sensor for performing photoelectric conversion of incident light and a focus control portion for adjusting a focal point based on an image signal obtained by the photoelectric conversion performed by the imaging sensor. The focus control portion includes a change detecting portion for detecting a change in size of a specific subject in a moving image based on the image signal, and adjusts the focal point so that the specific subject becomes in focus with the change taken into account.

This nonprovisional application claims priority under 35 U.S.C. § 119(a) on Patent Application No. 2007-176100 filed in Japan on Jul. 4, 2007 and Patent Application No. 2008-139319 filed in Japan on May 28, 2008, the entire contents of which are hereby incorporated by reference.

### BACKGROUND OF THE INVENTION

1. Field of the Invention

The present invention relates to an imaging apparatus such as a digital video camera, in particular, an imaging apparatus equipped with an automatic focus control function. In addition, the present invention relates to an automatic focus control method.

2. Description of Related Art

In general, the imaging apparatus such as a digital still camera or a digital video camera utilizes an automatic focus control using a TTL (Through The Lens) type contrast detection method. This type of automatic focus control can be divided roughly into a continuous AF and a single AF.

The continuous AF control a position of a focus lens successively based on a so-called hill-climbing control (hill-climbing method) so that AF score corresponding to a focus state of a subject is maintained at a maximum value or in the vicinity thereof. The continuous AF is an automatic focus control capable of maintaining a focus state of a moving subject, but it is necessary to search again a focal lens position for obtaining the maximum value of the AF score in the case where the AF score decreases due to a change in a subject distance after a focal lens position is once searched, for instance. In other words, it is necessary to search again a new position of the focus lens corresponding to the subject distance after the change.

There are two directions of moving the focus lens for searching again, i.e., the direction toward the near end and the direction toward the infinite point. Since the conventional imaging apparatus cannot know whether the subject distance has increased or decreased, it moves the focus lens in any one of the near end direction and the infinite point direction blindly for searching a new focal lens position. However, according to this method, the moving direction of the focus lens when a further searching process is started may not be appropriate to the moving direction of the subject in many cases.

For instance, if the focus lens is moved from the current lens position in the near end direction although the subject distance has increased, it is necessary to move the focus lens in the infinite point direction after it is found that the focal lens position cannot be searched. In this case, it takes long period of time until the focus state is obtained, and stability of the continuous AF may be deteriorated.

A similar problem may occur when the single AF is performed in continuous exposure. When a focus state is realized by the single AF for the first time, the entire movable range of the focus lens is usually the searching range of the focal lens position because the subject distance is not known. After this focus state is realized and the exposure is performed, the single AF is performed also for second and third exposures. However, since the conventional imaging apparatus does not know how the subject distance has changed between the exposures, it searches the focal lens position blindly also in the second single AF and in the third single AF. Therefore, there is a problem that it takes a long period of time until a focus state can be obtained.

Furthermore, in one conventional method about the automatic focus control, a subject distance is calculated from a focal length of the lens and a size of a face on the image, and the calculated subject distance is converted into a position of a focal lens position. Then, the focus lens is moved to the position obtained by the conversion so that focus state of the face is realized.

### SUMMARY OF THE INVENTION

An imaging apparatus according to an embodiment of the present invention includes an imaging sensor for performing photoelectric conversion of incident light and a focus control portion for adjusting a focal point based on an image signal obtained by the photoelectric conversion performed by the imaging sensor. The focus control portion includes a change detecting portion for detecting a change in size of a specific subject in a moving image based on the image signal, and adjusts the focal point so that the specific subject becomes in focus with the change taken into account.

More specifically, for instance, the light enters the imaging sensor through a focus lens for adjusting the focal point, and the imaging apparatus further includes a drive unit for driving the focus lens. The focus control portion adjusts the focal point by controlling a lens position of the focus lens using the drive unit based on the image signal, and controls the lens position based on the change in size of the specific subject so that the specific subject becomes in focus.

More specifically, for instance, the lens position when the specific subject is in focus is referred to as a focal lens position. The focus control portion realizes a focus state of the specific subject by moving the focus lens in a near end direction or in an infinite point direction while performing a searching process for searching the focal lens position. When the searching process is performed again after the focus state of the specific subject is once realized, the focus control portion determines a moving direction of the focus lens when the searching process is started again based on the change in size of the specific subject.

More specifically, for instance, when a decrease in the size is detected before the searching process is performed again, the focus control portion determines the moving direction when the searching process is started again to be the infinite point direction. On the contrary, when an increase in the size is detected before the searching process is performed again, the focus control portion determines the moving direction when the searching process is started again to be the near end direction.

In addition, for instance, the lens position when the specific subject is in focus is referred to as a focal lens position. The focus control portion realizes a focus state of the specific subject by moving the focus lens in a near end direction or in an infinite point direction while performing a searching process for searching the focal lens position. When the searching process is performed again after the focus state of the specific subject is once realized, the focus control portion sets a searching range of the focal lens position when the searching process is performed again based on the change in size of the specific subject.

More specifically, for instance, when a decrease in the size is detected before the searching process is performed again, the focus control portion sets a lens position range closer to the infinite point than the focal lens position obtained by a previous searching process to be the searching range. On the contrary, when an increase in the size is detected before the searching process is performed again, the focus control portion sets a lens position range closer to the near end than the focal lens position obtained by a previous searching process to be the searching range.

In addition, for instance, the imaging apparatus further includes a zoom lens for realizing an optical zoom for changing a size of an optical image formed on the imaging sensor. The focus control portion controls the lens position based on the change in size of the specific subject in the moving image and a change in magnification of the optical zoom in a period for obtaining the moving image.

More specifically, for instance, the lens position when the specific subject is in focus is referred to as a focal lens position. The focus control portion realizes a focus state of the specific subject by moving the focus lens in a near end direction or in an infinite point direction while performing a searching process for searching the focal lens position. When the searching process is performed again after the focus state of the specific subject is once realized, the focus control portion determines a moving direction of the focus lens when the searching process is started again based on the change in size of the specific subject and the change in magnification of the optical zoom.

More specifically, for instance, the change detecting portion estimates a change in distance between the specific subject and the imaging apparatus in real space based on the change in size of the specific subject and the change in magnification of the optical zoom. If the estimated change before the searching process is performed again indicates an increase of the distance, the focus control portion determines the moving direction when the searching process is started again to be the infinite point direction. If the estimated change before the searching process is performed again indicates a decrease of the distance, the focus control portion determines the moving direction when the searching process is started again to be the near end direction.

In addition, for instance, the focus control portion adjusts the focal point by driving and controlling a position of the imaging sensor based on the image signal, and may control the position of the imaging sensor based on the change in size of the specific subject so that the specific subject becomes in focus.

When the focal point is adjusted by driving and controlling a position of the imaging sensor, the focus lens, the lens position and the focal lens position in the above description describing a concrete structure of the imaging apparatus according to the present invention should be translated respectively into the imaging sensor, a sensor position (a position of the imaging sensor) and a focal sensor position as necessity.

More specifically, for instance, the imaging apparatus further includes an object detecting portion for detecting a specific type of object as the specific subject based on the image signal from each of frame images constituting the moving image, The change detecting portion detects the change in size of the specific subject based on a result of the detection performed by the object detecting portion.

More specifically, for instance, the imaging apparatus further includes a characteristic point detecting portion for extracting a plurality of characteristic points of the specific subject from a reference frame image in the moving image so as to detect positions of the plurality of characteristic points in each of frame images constituting the moving image. The change detecting portion detects the change in size of the specific subject based on a change in relative position between the plurality of characteristic points between different frame images.

More specifically, for instance, the specific type of object includes a face of a human.

An automatic focus control method according to an embodiment of the present invention is for adjusting a focal point based on an image signal from an imaging sensor for performing photoelectric conversion of incident light. The method includes the steps of detecting a change in size of a specific subject in a moving image based on the image signal, and adjusting the focal point so that the specific subject becomes in focus with the change taken into account.

Meanings and effects of the present invention will be apparent from the following description of embodiments. However, the embodiments described below are merely examples of the present invention. Meanings of the present invention and a term of each element are not limited to those described in the embodiments described below.

### BRIEF DESCRIPTION OF THE DRAWINGS

FIG. 1 is a general block diagram of an imaging apparatus according to an embodiment of the present invention.

FIG. 2 is a structural diagram showing an inside of an imaging unit shown in FIG. 1.

FIG. 3 is a diagram showing a movable range of a focus lens shown in FIG. 2.

FIG. 4 is a block diagram showing an inside of an AF evaluation portion incorporated in a main control unit shown in FIG. 1.

FIG. 5 is a block diagram of a part concerned with automatic focus control according to Example 1 of the present invention.

FIG. 6A is a diagram showing a frame image at timing T1 according to the Example 1 of the present invention.

FIG. 6B is a diagram showing a frame image at timing T2 according to the Example 1 of the present invention.

FIG. 7A is a graph showing a relationship between a lens position and an AF score corresponding to the timing T1 according to the Example 1 of the present invention.

FIG. 7B is a graph showing a relationship between the lens position and the AF score corresponding to the timing T2 according to the Example 1 of the present invention.

FIG. 8 is a diagram for explaining a searching direction of a focal lens position according to the Example 1 of the present invention.

FIG. 9 is a diagram showing a timing relationship among a plurality of record images according to the Example 2 of the present invention.

FIG. 10A is a diagram showing a frame image at a timing T3 according to the Example 2 of the present invention.

FIG. 10B is a diagram showing a frame image at a timing T_{A} according to the Example 2 of the present invention.

FIG. 11A is a graph showing a relationship between the lens position and the AF score corresponding to the timing T3 according to the Example 2 of the present invention.

FIG. 11B is a graph showing the relationship between the lens position and the AF score corresponding to the timing T_{A} according to the Example 2 of the present invention.

FIG. 12 is a diagram showing a searching range of the focus lens when single AF is performed according to the Example 2 of the present invention.

FIG. 13 is a block diagram of the part concerned with the automatic focus control according to the Example 3 of the present invention.

FIG. 14 is a diagram showing the frame image at the timing T1 as a reference frame image according to the Example 3 of the present invention.

FIG. 15 is a diagram showing the frame image at the timing T2 according to the Example 3 of the present invention.

FIG. 16 is a conceptual diagram showing that a size of the main subject is substantially proportional to a size of a figure formed by four characteristic points according to the Example 3 of the present invention.

FIG. 17 is a diagram showing that a size of a face on the image varies along with a change in an optical zoom magnification and a change in a subject distance according to the Example 5 of the present invention.

FIG. 18 is an operating flowchart of continuous AF according to the Example 5 of the present invention.

### DETAILED DESCRIPTION OF THE PREFERRED EMBODIMENTS

Hereinafter, an embodiment of the present invention will be described with reference to the attached drawings. In the individual drawings to be referred, the same parts are denoted by the same reference numerals so that overlapping description thereof can be omitted as a rule. Example 1 to Example 7 will be described later, but first, matters common to all example or matters that will be referred to in each example will be described.

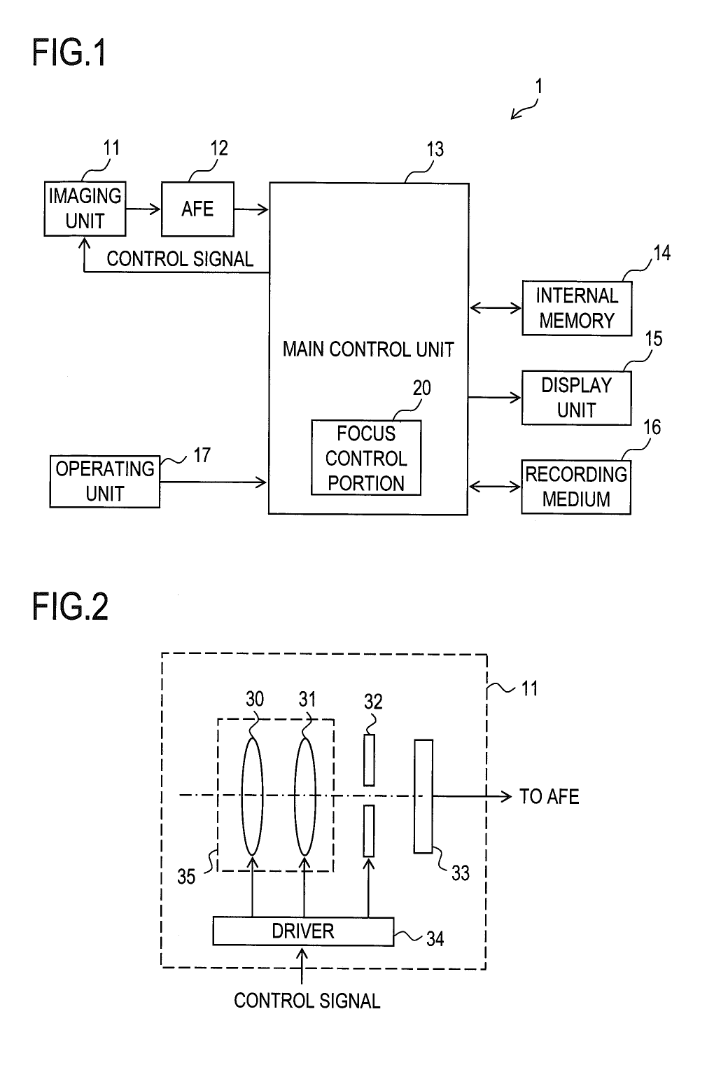

FIG. 1 is a general block diagram of an imaging apparatus 1 according to an embodiment of the present invention. The imaging apparatus 1 shown in FIG. 1 is a digital still camera capable of obtaining and recording still images or a digital video camera capable of obtaining and recording still images and moving images.

The imaging apparatus 1 includes an imaging unit 11, an AFE (Analog Front End) 12, a main control unit 13, an internal memory 14, a display unit 15, a recording medium 16 and an operating unit 17.

FIG. 2 illustrates an internal structure of the imaging unit 11. The imaging unit 11 includes an optical system 35, an iris diaphragm 32, an imaging sensor 33 and a driver 34. The optical system 35 has a plurality of lenses including a zoom lens 30 for adjusting zoom magnification of the optical system 35 and a focus lens 31 for adjusting a focal point of the optical system 35. The zoom lens 30 and the focus lens 31 can move in the optical axis direction. The driver 34 controls movements of the zoom lens 30 and the focus lens 31 based on a control signal from the main control unit 13 so as to control the zoom magnification and a focal position of the optical system 35. In addition, the driver 34 controls an aperture (a size of the opening) of the iris diaphragm 32 based on a control signal from the main control unit 13.

Incident light from the subject enters the imaging sensor 33 through the lenses of the optical system 35 and the iris diaphragm 32. The lenses of the optical system 35 form an optical image of the subject on the imaging sensor 33.

The imaging sensor 33 is made up of a CCD (Charge Coupled Devices) image sensor or a CMOS (Complementary Metal Oxide Semiconductor) image sensor, for instance. The imaging sensor 33 performs photoelectric conversion of the light (the optical image) entering through the optical system 35 and the iris diaphragm 32 so as to output an electric signal obtained by the photoelectric conversion to the AFE 12.

The AFE 12 amplifies an analog signal supplied from the imaging unit 11 (imaging sensor 33) and converts the amplified analog signal into a digital signal. The AFE 12 outputs the digital signal sequentially to the main control unit 13.

The main control unit 13 includes a CPU (Central Processing Unit), a ROM (Read Only Memory) and a RAM (Random Access Memory) and the like so as to work also as a video signal processing unit. The main control unit 13 generates a video signal indicating the image obtained by the imaging unit 11 (hereinafter referred to also as a “taken image” or a “frame image”) based on an output signal of the AFE 12. In addition, the main control unit 13 also has a function as a display control unit for controlling display contents of the display unit 15, so as to perform control necessary for display on the display unit 15.

The internal memory 14 is made up of an SDRAM (Synchronous Dynamic Random Access Memory) or the like and stores temporarily various data generated in the imaging apparatus 1. The display unit 15 is a display device made up of a liquid crystal display panel or the like and displays an image that has taken in the adjacent frame and images recorded on the recording medium 16 under control by the main control unit 13. The recording medium 16 is a nonvolatile memory such as an SD (Secure Digital) memory card or the like for storing taken images and the like under control by the main control unit 13. The operating unit 17 receives an external operation. Operating contents of the operating unit 17 is transmitted to the main control unit 13.

The imaging apparatus 1 has operating modes including shooting mode in which a still image or a moving image can be taken and recorded, and reproducing mode in which the still image or the moving image recorded on the recording medium 16 can be reproduced and displayed on the display unit 15. The modes are switched in accordance with the operation of the operating unit 17. In the shooting mode, the imaging unit 11 exposes sequentially at a predetermined frame period (e.g., 1/60 seconds). The following description is about the action in the shooting mode unless otherwise specified.

It is supposed that a first, a second, a third, . . . , an (n−2)th, an (n−1)th and an n-th frame come in this order (here, n is an integer of 2 or larger) each time when the frame period passes, and that the taken image obtained in the first, the second, the third, . . . , the (n−2)th, the (n−1)th and the n-th frame are referred to as a first, a second, a third, . . . , an (n−2)th, an (n−1)th and an n-th frame image, respectively. The plurality of frame images arranged sequentially constitute a moving image.

As shown in FIG. 1, the main control unit 13 includes a focus control portion 20. The focus control portion 20 controls a position of the focus lens 31 via the driver 34 based on an output signal of the AFE 12 (i.e., an output signal of the imaging sensor 33) so that automatic focus control is realized.

Hereinafter, a position of the focus lens 31 is simply referred to as a “lens position”. In addition, the control signal supplied from the focus control portion 20 to the driver 34 for controlling a position of the focus lens 31 is particularly referred to as a “lens position control signal”.

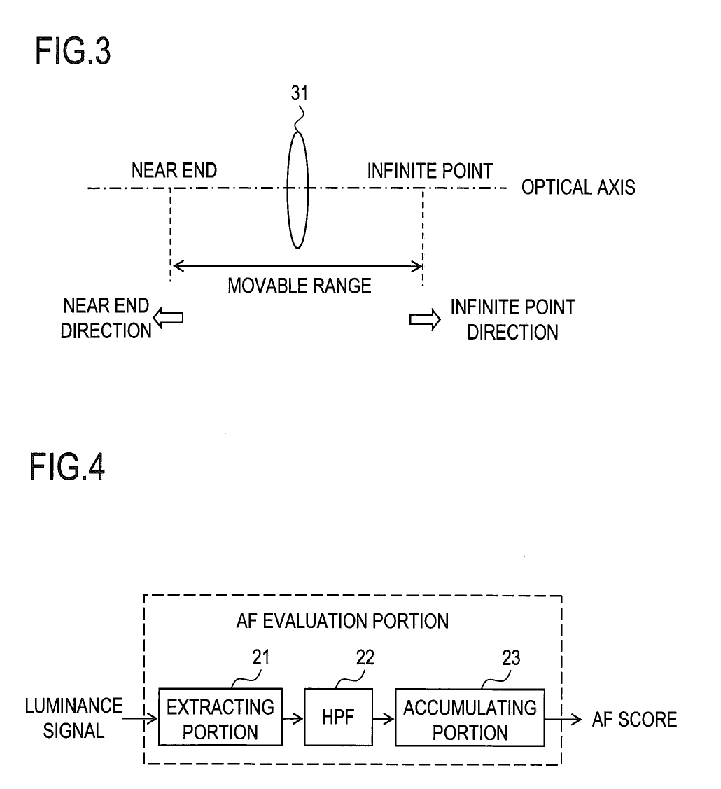

The focus lens 31 can be moved along in the optical axis direction of the optical system 35, and the optical axis direction is divided into a near end direction and an infinite point direction. As shown in FIG. 3, a movable range of the focus lens 31 is a range between a predetermined near end and a predetermined infinite point. When the lens position is disposed at the near end, a subject distance of the subject in focus becomes minimum. When the lens position is disposed at the infinite point, the subject distance of the subject in focus becomes maximum. Furthermore, the subject distance of the subject in focus increases as the lens position moves from the near end to the infinite point. Here, the subject distance of a certain subject means a distance between the subject and the imaging apparatus 1 in the real space.

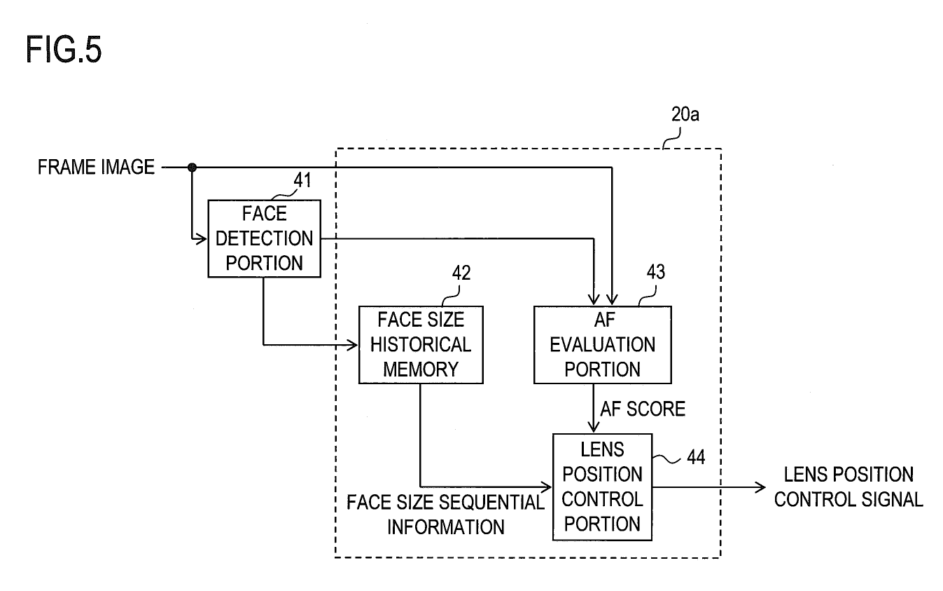

A method of calculating an AF score that is used for the automatic focus control will be described. FIG. 4 is an internal block diagram of an AF evaluation portion for calculating the AF score. The AF evaluation portion shown in FIG. 4 has a structure including an extracting portion 21, an HPF (high pass filter) 22 and an accumulating portion 23. The AF evaluation portion shown in FIG. 4 is disposed in the main control unit 13, for instance. The AF score is calculated for each of the frame images. Operations of individual portions in the AF evaluation portion shown in FIG. 4 when the AF score is calculated for one noted frame image will be described.

The extracting portion 21 extracts a luminance signal from the video signal of the noted frame image. On this occasion, only the luminance signal in an AF evaluation area defined in the frame image is extracted. The HPF 22 extracts only a predetermined high frequency component in the luminance signal extracted by the extracting portion 21.

The accumulating portion 23 accumulates the high frequency component extracted by the HPF 22 so as to output the accumulated value as the AF score. The AF score is substantially proportional to a contrast quantity (edge quantity) of the image in the AF evaluation area so as to increase as the contrast quantity increases.

Hereinafter, Example 1 to Example 7 will be described as examples of the automatic focus control. Description in a certain example will be referred also in other examples appropriately as it can be applied to other examples as long as no contradiction arises.

### Example 1

First, Example 1 of the present invention will be described. FIG. 5 is a block diagram of a part concerned with the automatic focus control according to the Example 1. The main control unit 13 (see FIG. 1) according to the Example 1 includes a face detection portion 41 and a focus control portion 20a as shown in FIG. 5. The focus control portion 20a is used as the focus control portion 20 in FIG. 1. The focus control portion 20a includes individual portions denoted by reference numerals 42 to 44. Although the face detection portion 41 is disposed at the outside of the focus control portion 20a in FIG. 5, it is possible to consider that the face detection portion 41 is disposed inside the focus control portion 20a. The Example 1 is intended to show the case where a face of a human is included in each of the frame images.

The face detection portion 41 is supplied with the frame images as input images. The face detection portion 41 detects a face of a human from the input image based on the video signal (image data) of the input image so as to extract a face area including the detected face for each of the input images. Various methods for detecting a face included in an image are known, and the face detection portion 41 can adopt any of the methods. For instance, a method described in JP-A-2000-105819 may be adopted. JP-A-2000-105819 discloses a method for detecting a face (face area) by extracting a flesh color area from an input image. In addition, another method for detecting a face (face area) described in JP-A-2006-211139 or JP-A-2006-72770 may be adopted.

As a typical method, for instance, an image of a noted area set in an input image is compared with a reference face image having a predetermined image size so as to decide similarity between the images, and it is detected based on the similarity whether or not the noted area includes a face (i.e., whether the noted area is the face area or not). The similarity decision is performed by extracting characteristic quantity that is effective for distinguishing a face from others. The characteristic quantity can be a horizontal edge, a vertical edge, a right diagonal edge, a left diagonal edge or the like.

In the input image, the noted area is shifted one by one pixel in the left and right direction or in the up and down direction. Then, an image of the noted area after the shifting process is compared with the reference face image so as to decide similarity between the images again, so that similar detection is performed. In this way, the noted area is updated while is shifted one by one pixel from the upper left to the lower right of the input image, for instance. In addition, the input image is reduced at a certain ratio, and the same face detection process is performed on the reduced image. This process is repeated so that a face of any size can be detected from the input image.

A size of the face detected by the face detection portion 41 is referred to as a “face size”. The face size means a size of the detected face on the frame image and is expressed by an area (the number of pixels) of the face area including the face, for instance. In addition, a position of the face detected by the face detection portion 41 is referred to as a “face position”. The face position means a position of the detected face on the frame image and is expressed by coordinates of the center of the face area including the face, for instance.

A face size historical memory 42 stores face sizes of the latest k frames arranged in time series (k is an integer of 2 or larger). For instance, just after a face size of the n-th frame image is specified by the face detection process on the n-th frame image, at least face sizes of the (n−k+1)th to the n-th frame images are stored in the face size historical memory 42. A set of the face sizes stored in the face size historical memory 42 is collectively referred to as “face size sequential information”. The face size sequential information is delivered to a lens position control portion 44.

An AF evaluation portion 43 is a portion similar to the AF evaluation portion shown in FIG. 4 and calculates AF scores of the individual frame images. However, the focus control portion 20a makes the AF evaluation area includes the face area based on the face position (and the face size) specified by the face detection portion 41. A position and a size of the AF evaluation area on the frame image may be different between different frame images, but it is supposed that the AF evaluation areas on all the frame images have the same position and the same size in the following description for convenience of description (the same is true on the other examples that will be described later).

The lens position control portion 44 generates a lens position control signal for controlling a lens position based on face size sequential information and the AF score from the AF evaluation portion 43 and delivers the same to the driver 34 (see FIG. 2) so as to control the lens position.

The Example 1 is intended to show the case where the focus control portion 20a realizes a so-called continuous AF. The continuous AF is an automatic focus control to maintain focus on a subject following a movement of the subject. The focus on a subject means that the focus is adjusted on the subject. In the Example 1, a face of a human is dealt with as a main subject because the face area is included in the AF evaluation area while the continuous AF is performed so that the main subject becomes in focus. In addition, a lens position when the main subject is in focus is referred to as a “focal lens position”.

As to a basic action, the lens position control portion 44 moves the lens position in the near end direction or the infinite point direction one by one step of a predetermined movement while it refers to the AF score that is calculated for each of the frame images and controls the lens position by using a so-called hill-climbing method so that the AF score becomes a maximum value (or in the vicinity thereof). When the main subject becomes in focus, the AF score becomes the maximum value (or substantially the maximum value). Therefore, the lens position in which the AF score becomes the maximum value is the focal lens position. Therefore, the control process of the lens position as described above can be called a searching process of the focal lens position. In the searching process, the lens position control portion 44 controls continuously a position of the focus lens 31 via the driver 34 in the direction of increasing the AF score. As a result, a contrast quantity of an image within the AF evaluation area is maintained to be the maximum value (or in the vicinity thereof) with respect to the same optical image. Note that the maximum value of the AF score means a local-maximal value in the strict sense.

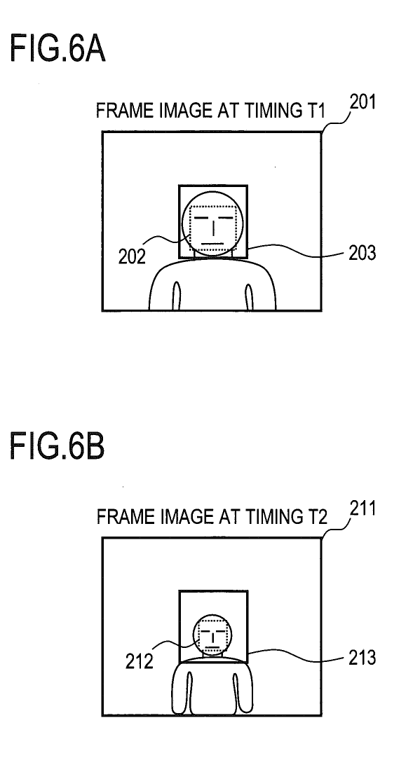

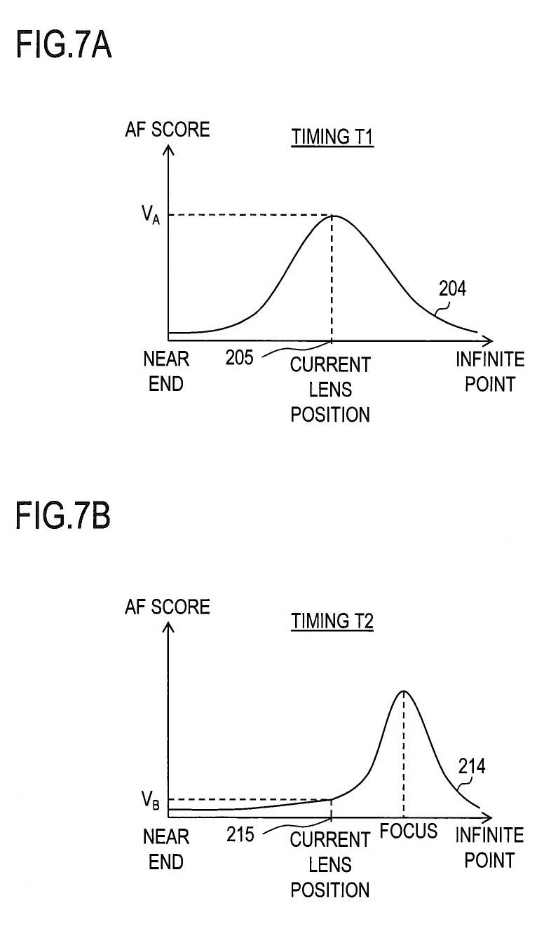

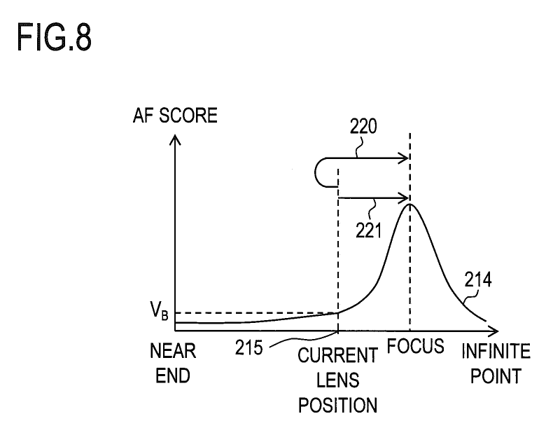

When the focused state of the main subject is realized by the continuous AF in the state where the main subject and the imaging apparatus 1 are standing still, the lens position is substantially stopped at the focal lens position. However, if the main subject is moved largely in the direction so that a subject distance of the main subject is change for instance, it is necessary to search the focal lens position by using the hill-climbing method again. The action of the second searching process will be described with reference to FIGS. 6A, 6B, 7A and 7B.

It is supposed that a subject distance of the main subject has increased during the period between the timings T1 and T2. The timing T2 comes after the timing T1. A solid line rectangle denoted by reference numeral 201 in FIG. 6A indicates a frame image at the timing T1, and a solid line rectangle denoted by reference numeral 211 in FIG. 6B indicates a frame image at the timing T2. A broken line rectangle area denoted by reference numeral 202 in FIG. 6A is the face area as the main subject extracted from the frame image 201, and a broken line rectangle area denoted by reference numeral 212 in FIG. 6B is the face area as the main subject extracted from the frame image 211. A solid line rectangle area denoted by reference numeral 203 in FIG. 6A is the AF evaluation area defined in the frame image 201, and a solid line rectangle area denoted by reference numeral 213 in FIG. 6B is the AF evaluation area defined in the frame image 211.

FIGS. 7A and 7B are graphs indicating a relationship between the lens position and the AF score. A curve 204 in FIG. 7A indicates a relationship between the lens position and the AF score corresponding to the frame image 201 shown in FIG. 6A, and a curve 214 in FIG. 7B indicates a relationship between the lens position and the AF score corresponding to the frame image 211 shown in FIG. 6B.

In each graph showing the curve 204 or 214, the horizontal axis represents a lens position, and the right side of the horizontal axis corresponds to the infinite point side. In FIG. 7A, reference numeral 205 denotes a lens position at the timing T1. In FIG. 7B, reference numeral 215 denotes a lens position at the timing T2. Furthermore, the AF score obtained from the frame image 201 shown in FIG. 6A is denoted by V_{A} while the AF score obtained from the frame image 211 shown in FIG. 6B is denoted by VB. Note that only the AF score V_{A} is obtained from the frame image 201, and that the focus control portion 20a recognizes not all the shape of the curve 204 at the timing T1 (the same is true on the curve 214).

The main subject is in focus at the timing T1 by the continuous AF that has been performed before the timing T1, so the lens position 205 at the timing T1 corresponds to the focal lens position. Therefore, the AF score V_{A} has a maximum value that the AF score can be.

It is supposed that a figure corresponding to the main subject moves away from the imaging apparatus 1 in the period from the timing T1 to the timing T2, so that the subject distance of the main subject is larger at the timing T2 than at the timing T1. If the movement of the main subject is rapid, the lens position cannot follow the focal lens position. This example is intended to support such a state, and it is supposed that the lens position is not changed in the period from the timing T1 to the timing T2. Then, the AF score (VB) decreases rapidly at the timing T2 compared with that at the timing T1. The lens position control portion 44 shown in FIG. 5 detects this decrease in the AF score and decides that the focus state of the main subject has been lost. Then, it performs the searching process again after the timing T2. On this occasion, the lens position control portion 44 decides a moving direction of the focus lens 31 (i.e., the searching direction of the focal lens position) when the searching process is started again based on the face size sequential information.

The face size sequential information for deciding the moving direction includes a face sizes in the frame images 201 and 211. The face size of the face area 212 in the frame image 211 is smaller than the face size of the face area 202 in the frame image 201 because of an increase in the subject distance. If such a decrease in face size is detected before the searching process is performed again, the lens position control portion 44 decides that the subject distance has increased, so as to decide the moving direction of the focus lens 31 when the searching process is started again to be the infinite point direction. Therefore, after the timing T2, with respect to the lens position 215, the focus lens 31 is moved in the infinite point direction while the maximum AF score is searched again (i.e., the focal lens position is searched again).

As understood from the curve 214 shown in FIG. 7B and FIG. 8, the maximum value (local maximum value) of the AF score is not found, and the AF score decreases due to the movement in the near end direction even if the focus lens 31 is moved in the near end direction with respect to the lens position 215. Therefore, if the moving direction of the focus lens 31 is set to the near end direction when the searching process is started again, as shown by a curve 220 with an arrow in FIG. 8, the focus lens 31 is moved once in the near end direction. Then, after a decrease in the AF score is observed because of the movement in the near end direction, the moving direction of the focus lens 31 is set again to be the infinite point direction so that the focal lens position is finally found by the lens position adjustment afterward.

On the other hand, if it is decided that the moving direction of the focus lens 31 when the searching process is started again is the infinite point direction using moving direction decision based on the face size sequential information, the focal lens position can be found in a short period of time as shown by a straight line 221 with an arrow in FIG. 8. As a result, stability of the continuous AF as well as a focusing speed is improved. In addition, it is not necessary to calculate the subject distance unlike the conventional method (e.g., the method described in JP-A-2003-75717). Thus, a computation load is not heavy.

Although it is different from the state shown in FIG. 7B, if the maximum AF score is not found after the timing T2 even if the focus lens 31 is moved in the infinite point direction with respect to the lens position 215, the lens position that makes the AF score the maximum value (local maximum value) is further searched after reversing the moving direction of the focus lens 31.

In addition, the case where the subject distance of the main subject becomes larger at the timing T2 than at the timing T1 is exemplified in the above description. If the subject distance of the main subject becomes smaller at the timing T2 than at the timing T1, the moving direction of the focus lens 31 is decided to be the opposite direction. More specifically, if a face size of the face area 212 in the frame image 211 is larger than a face size of the face area 202 in the frame image 201, the lens position control portion 44 decides that the subject distance has decreased. Then, it decides the moving direction of the focus lens 31 when the searching process is started again to be the near end direction.

The relationship between the frame image 201 and the frame image 211 shown in FIGS. 6A and 6B will be further described. The frame images 201 and 211 are (n−k+1)th and n-th frame images, respectively (k is an integer of 2 or larger as described above). For instance, it is supposed that k is two, simply. In this case, the above-mentioned moving direction is decided based on a change in the face size during a period between neighboring frame images.

Of course, it is possible that k is 3 or larger. If k is 3, a change in the face size during the period between (n−2)th and n-th frames is detected based on the face sizes of the (n−2)th to the n-th frame images, so that the above-mentioned moving direction is decided based on a result of the detection. For instance, when a face size of the (n−j) frame image is expressed by FS[n−j] (j is an integer of 0 or larger), it is decided that the face size decreased between the (n−2)th and the n-th frames if the expression “FS[n−2]>FS[n−1]>FS[n]” holds. Then, the moving direction of the focus lens 31 when the searching process is started again is decided to be the infinite point direction. On the other hand, if the expression “FS[n−2]<FS[n−1]<FS[n]” holds, it is decided that the face size increased between the (n−2)th and the n-th frames. Then, the moving direction of the focus lens 31 when the searching process is started again is decided to be the near end direction.

### Example 2

Next, Example 2 of the present invention will be described. A block diagram of a part concerned with the automatic focus control according to the Example 2 is the same as that shown in FIG. 5, so overlapping illustration is omitted. The main control unit 13 (see FIG. 1) according to the Example 2 includes the face detection portion 41 and the focus control portion 20a shown in FIG. 5. The focus control portion 20a is used as the focus control portion 20 shown in FIG. 1. Example 2 is intended to show the case where a face of a human is included in each of the frame images similarly to the Example 1.

However, Example 2 is also intended to show the case where the focus control portion 20a realizes so-called single AF. The single AF is a type of automatic focus control in which if a focal lens position is once searched, the lens position is fixed to the focal lens position after that.

In the single AF, for instance, the lens position control portion 44 moves the focus lens 31 step by step of a predetermined movement within the searching range, so that a latest AF score is obtained from the AF evaluation portion 43 each time when the focus lens 31 is moved. Then, the lens position that makes the AF score the maximum value within the searching range is specified as the focal lens position, and a real lens position is moved to the specified focal lens position so as to fix the lens position. Thus, the main subject within the AF evaluation area becomes in focus. As understood from the above description, the searching range is a range of the lens position where the focus lens 31 is to be disposed for searching the focal lens position (in other words, a range of moving the focus lens 31 for searching the focal lens position). Typically, the searching range is the entire of the movable range of the focus lens 31, for instance (i.e., the entire range between the near end and the infinite point).

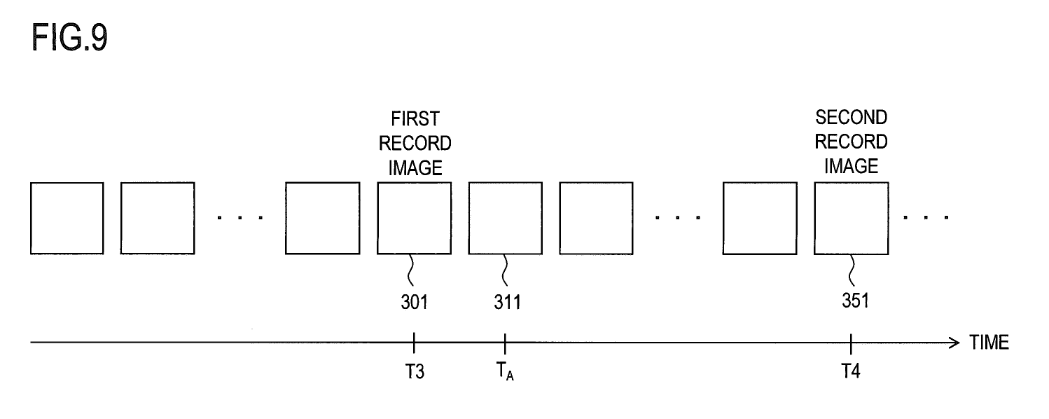

It is supposed that a plurality of still images are obtained and recorded at a relatively short time interval by using a continuous exposure function or the like with a concrete example as shown in FIG. 9. More specifically, it is supposed that the frame image at the timing T3 is recorded as a first record image in the recording medium 16 and that the frame image at the timing T4 is recorded as a second record image in the recording medium 16, responding to an operation of the operating unit 17 shown in FIG. 1. The timing T4 comes after the timing T3, but a period of time between them is relatively short.

In addition, it is supposed that the frame image (and the first record image) at the timing T3 is denoted by reference numeral 301, and the frame image (and the second record image) at the timing T4 is denoted by reference numeral 351 as shown in FIG. 9. In addition, a plurality of frame images have been obtained before the timing T3, and each of the plurality of frame images is updated and displayed as a through image on the display unit 15 before the timing T3. The plurality of frame images obtained before the timing T3 is used for realizing the single AF with respect to the frame image 301.

Similarly, a plurality of frame images are obtained after the timing T3 and before the timing T4, and each of the plurality of frame images is updated and displayed as a through image on the display unit 15 (however, may not be displayed). The plurality of frame images obtained after the timing T3 and before the timing T4 is used for realizing the single AF with respect to the frame image 351. In addition, a certain timing between the timings T3 and T4 is represented by a timing T_{A}, and the frame image at the timing T_{A} is denoted by reference numeral 311.

In order to realize the single AF with respect to the frame image 301, the focus control portion 20a performs the single AF before the timing T3. On this occasion, the searching range described above is to be the entire of the movable range of the focus lens 31, for instance. More specifically, before the timing T3, the lens position control portion 44 moves the focus lens 31 from the near end to the infinite point (or from the infinite point to the near end) one by one step of a predetermined movement, and a latest AF score is obtained from the AF evaluation portion 43 in each movement. Then, a lens position that makes the AF score the maximum value within the searching range is specified as the focal lens position, so that a real lens position is moved to the specified focal lens position for fixing the lens position. The frame image 301 is obtained in this state.

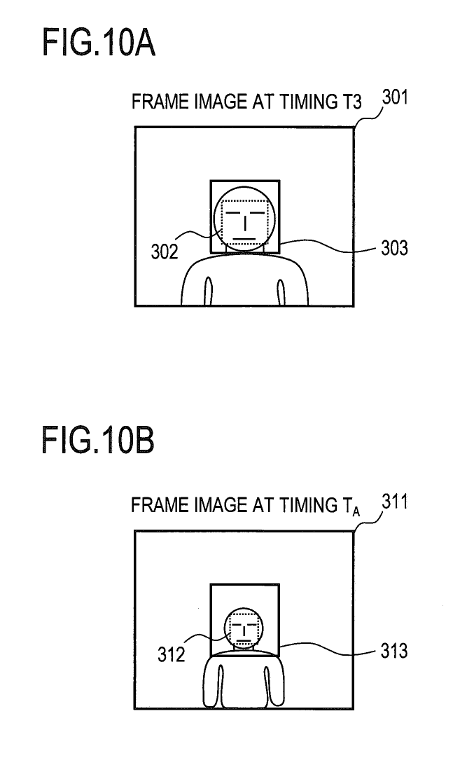

It is supposed that the subject distance of the main subject that had been constant before the timing T3 increased in the period between the timing T3 and the timing T_{A}. FIG. 10A shows the frame image 301 at the timing T3, and FIG. 10B shows the frame image 311 at the timing T_{A}. In FIG. 10A, a broken line rectangle area denoted by reference numeral 302 is a face area as a main subject extracted from the frame image 301, and a solid line rectangle area denoted by reference numeral 303 is an AF evaluation area defined in the frame image 301. In FIG. 10B, a broken line rectangle area denoted by reference numeral 312 is a face area as a main subject extracted from the frame image 311, and a solid line rectangle area denoted by reference numeral 313 is an AF evaluation area defined in the frame image 311.

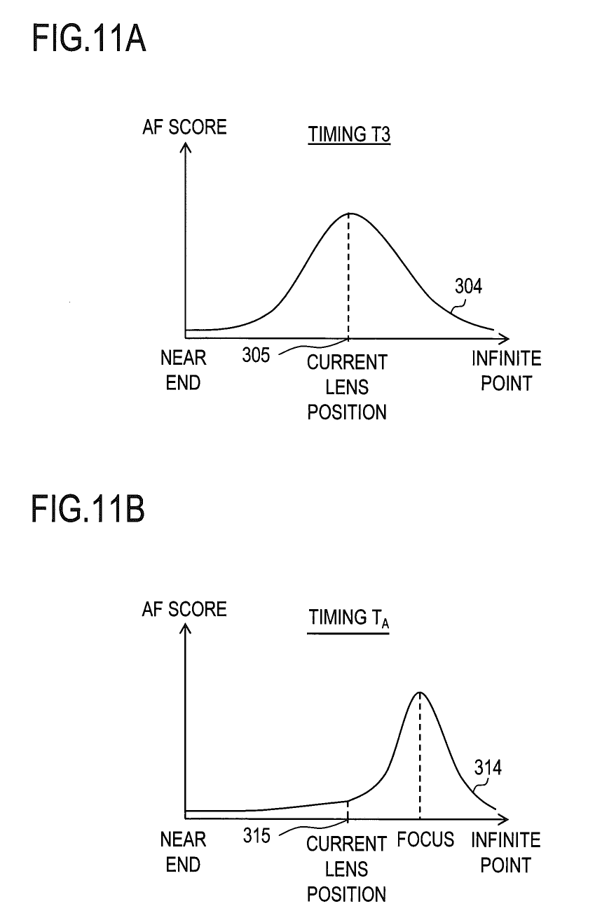

FIGS. 11A and 11B are graphs showing a relationship between the lens position and the AF score. A curve 304 in FIG. 11A shows a relationship between the lens position and the AF score corresponding to the frame image 301 shown in FIG. 10A, and a curve 314 in FIG. 11B shows a relationship between the lens position and the AF score corresponding to the frame image 311 in FIG. 10B.

In each of the graphs of the curves 304 and 314, the horizontal axis represents the lens position, and the right side of the horizontal axis corresponds to the infinite point side. In FIG. 11A, reference numeral 305 denotes the lens position at the timing T3. In FIG. 11B, reference numeral 315 denotes the lens position at the timing T_{A}. The timing T_{A} is a timing before the single AF is performed with respect to the frame image 351 (see FIG. 9). The lens positions 305 and 315 are the same. The lens position 305 is identical to the focal lens position, but the lens position 315 is not identical to the focal lens position because of a change in the subject distance. The AF score of the frame image 311 at the timing T_{A} is substantially decreased.

The focus control portion 20a performs the single AF with respect to the frame image 351 in the period between the timings T_{A} and T4, and the above-mentioned searching range on this occasion is determined based on the face size sequential information.

The face size sequential information for deciding the searching range includes a face sizes with respect to the frame images 301 and 311. The face size of the face area 312 in the frame image 311 is smaller than the face size of the face area 302 in the frame image 301 because of an increase in the subject distance (see FIGS. 10A and 10B). If such a decrease in the face size is detected before performing the single AF with respect to the frame image 351 (i.e., the searching process of the focal lens position with respect to the frame image 351), the lens position control portion 44 decides that the subject distance has increased and sets the searching range of the single AF with respect to the frame image 351 to be closer to the infinite point side than the current lens position.

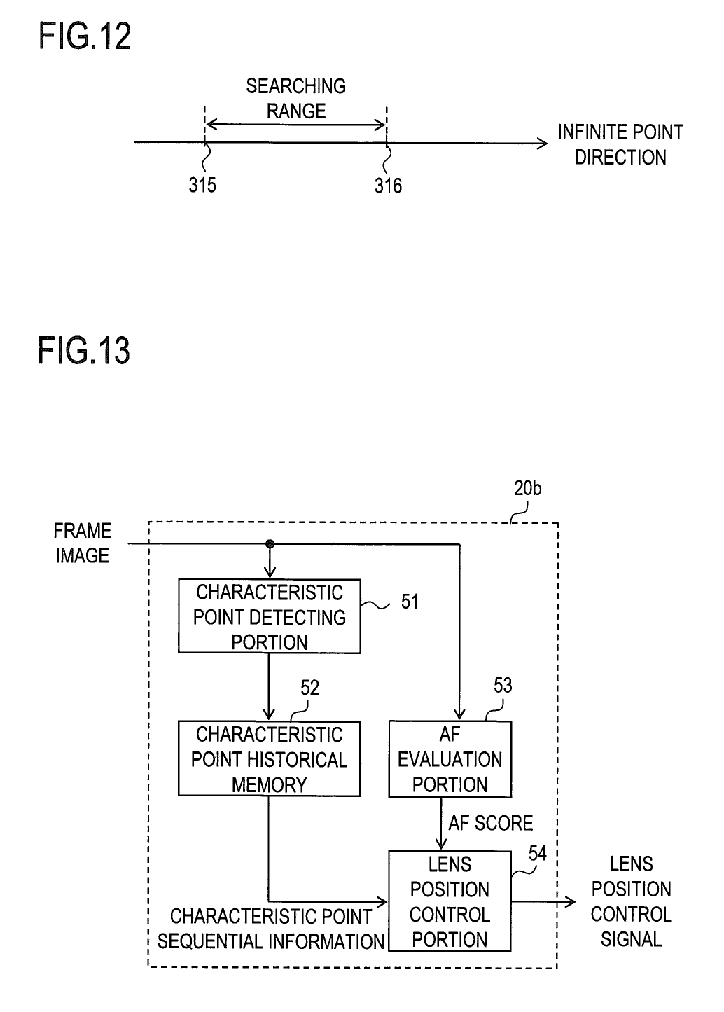

More specifically, the lens position control portion 44 decides the lens position range between the lens position 315 at the timing T_{A} (see FIGS. 11B and 12) and a lens position 316 located closer to the infinite point than the lens position 315 to be the searching range of the single AF with respect to the frame image 351. After that, in the period between the timings T_{A} and T4, the focus lens 31 is moved from the lens position 315 to the lens position 316 in the infinite point direction step by step of a predetermined movement, so that a latest AF score is obtained from the AF evaluation portion 43 in every movement. Then, the lens position that makes the AF score the maximum value within the searching range (searching range between the lens positions 315 and 316) is specified as the focal lens position, and a real lens position is moved to the specified focal lens position so as to fix the lens position. The frame image 351 shown in FIG. 9 is obtained in this state.

The lens position 316 shown in FIG. 12 that is an end point of the searching range is simply regarded as the infinite point for instance. However, it is possible to regard a lens position between the lens position 315 and the infinite point to be the lens position 316. For instance, a variation quantity in the subject distance in the period between the timings T3 and T_{A} is estimated from comparison between the AF score of the frame image 301 and the AF score of the frame image 311 or comparison between the face size of the face area 302 and the face size of the face area 312 (see FIGS. 9, 10A and 10B). If it is estimated that the variation quantity is relatively small, the lens position 316 may be set between the lens position 315 and the infinite point in accordance with the estimated variation quantity.

As described above, if the searching range in the single AF is set based on the face size sequential information, searching time of the focal lens position can be shortened so that speeding up of focusing can be realized in the single AF.

In addition, the case where the subject distance of the main subject becomes larger in the timing T_{A} than in the timing T3 is exemplified in the above description. If the subject distance of the main subject becomes smaller in the timing T_{A} than in the timing T3, the searching range is to be a range of the opposite direction to the case described above. More specifically, if the face size of the face area 312 in the frame image 311 is larger than the face size of the face area 302 in the frame image 301, the lens position control portion 44 decides that the subject distance has decreased, so that the searching range of the single AF with respect to the frame image 351 is determined to be closer to the near end than the current lens position. The process after that is the same as the process described above except for the different searching ranges.

A relationship between the frame image 301 and the frame image 311 shown in FIGS. 10A and 10B will be further described. The frame images 301 and 311 are the (n−k+1)th and the n-th frame images, respectively, for instance (k is an integer of two or larger as described above). In a simple example, k is two. In this case, the above-mentioned searching range is determined based on a variation of the face size between the neighboring frame images.

Of course, k may be three or larger. If k equals to three, a change in the face size between the (n−2)th and the n-th frames is detected based on the face sizes of the (n−2)th to the n-th frame images, so that the above-mentioned searching range is decided based on a result of the detection. For instance, when a face size of the (n−j)th frame image is expressed by FS[n−j] (j is an integer of 0 or larger), it is decided that the face size decreased between the (n−2)th and the n-th frames if the expression “FS[n−2]>FS[n−1]>FS[n]” holds. Then, the searching range of the single AF with respect to the frame image 351 is decided to be closer to the infinite point side than the current lens position. In contrast, if the expression “FS[n−2]<FS[n−1]<FS[n]” holds, it is decided that the face size increased between the (n−2)th and the n−th frames. Then, the searching range of the single AF with respect to the frame image 351 is determined to be closer to the near end side than the current lens position.

If the third record image (or the fourth, the fifth, . . . record image) is further obtained and recorded after the timing T4 shown in FIG. 9, the searching range is set similarly to the above description. More specifically, a change in the face size with respect to the timing T4 is detected, so that the searching range of the single AF with respect to the third record image should be determined based on a result of the detection (the same is true on the fourth, the fifth, . . . record image).

### Example 3

Next, Example 3 of the present invention will be described. FIG. 13 is a block diagram of a part concerned with the automatic focus control of the Example 3. The main control unit 13 (see FIG. 1) according to the Example 3 includes a focus control portion 20b shown in FIG. 13. The focus control portion 20b is used as the focus control portion 20 shown in FIG. 1. The focus control portion 20b includes individual portions denoted by reference numerals 51 to 54.

The focus control portion 20b sets an AF evaluation area in each of frame images. The AF evaluation area is a rectangular area that is a part of the frame image. Simply, for instance, a predetermined rectangular area located in the middle of the frame image or in the vicinity thereof is set as the AF evaluation area.

Otherwise, for instance, an area including the subject having the shortest subject distance among subjects included in the frame image may be set as the AF evaluation area. In this case, the AF evaluation area is set as described below. The frame image is divided into a plurality of different candidate AF evaluation areas, and the lens position is moved from the near end to the infinite point while the AF score of each of the candidate AF evaluation areas is calculated. Thus, a relationship between the lens position and the AF score as shown by the curve 204 in FIG. 7A is obtained for each of the candidate AF evaluation areas. Then, the lens position that makes the AF score the maximum value (local maximum value) is specified for each of the candidate AF evaluation areas, and the candidate AF evaluation area in which the specified lens position is closest to the near end is finally set as the AF evaluation area.

The focus control portion 20b deals with the subject within the set AF evaluation area as the main subject.

The characteristic point detecting portion 51 extracts a plurality of characteristic points in the main subject by using a characteristic point extractor (not shown). The characteristic point is a point that can be distinguished from surrounding points and can be traced easily. The characteristic point can be extracted automatically by using a known characteristic point extractor (not shown) for detecting a pixel in which density variation quantity becomes large in the horizontal and the vertical directions. The characteristic point extractor is Harris corner detector, SUSAN corner detector, or KLT corner detector, for instance.

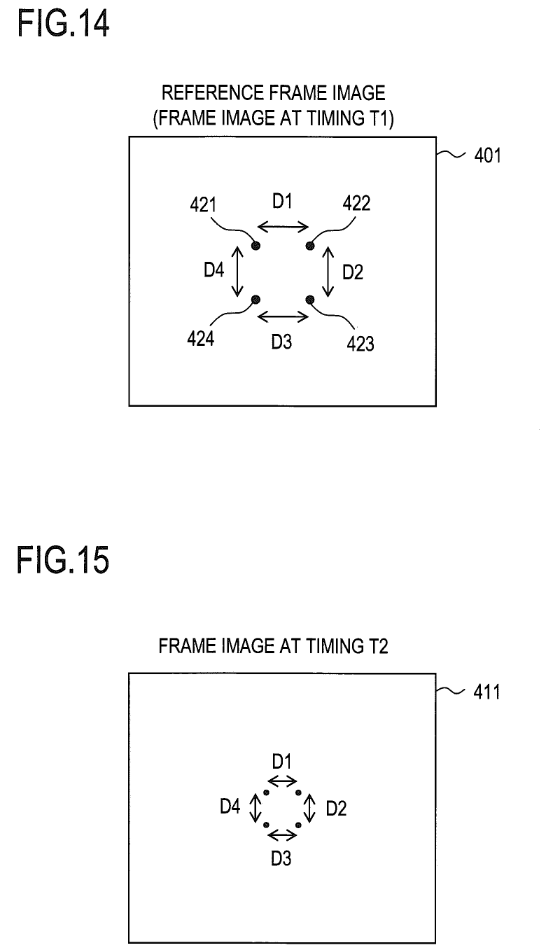

It is supposed that four characteristic points including the first to the fourth characteristic points are detected from a certain frame image (hereinafter referred to as a reference frame image). FIG. 14 illustrates the first to the fourth characteristic points in the reference frame image denoted by reference numerals 421 to 424, respectively. Actually, five or more characteristic points may be extracted from the AF evaluation area including the main subject. In this case, it is supposed that the first to the fourth characteristic points are selected from the five or more characteristic points. Note that the reference frame image is denoted by the reference numeral 401, which is also referred to as a frame image 401.

A frame in which the reference frame image can be obtained is referred to as a reference frame. When the frame image of the next frame succeeding the reference frame is obtained, the characteristic point detecting portion 51 specifies the first to the fourth characteristic points in the frame image by a tracking process. When two frame images neighboring temporally are referred to as a previous frame image and a current frame image, a position of the characteristic point of the current frame image can be specified by regarding an area close to a position of the characteristic point in the previous frame image to be a characteristic point searching area and by performing an image matching process within the characteristic point searching area of the current frame image. The image matching process includes, for instance, forming a template in the image within a rectangular area having a center at the position of the characteristic point in the previous frame image, and calculating a similarity between the template and the image within the characteristic point searching area of the current frame image. The characteristic point detecting portion 51 performs this tracking process repeatedly so as to track the first to the fourth characteristic points extracted in the reference frame in the moving image after the reference frame.

In addition, the characteristic point detecting portion 51 calculates a distance between two of the first to the fourth characteristic points. In case of this example, as shown in FIG. 14, a distance D1 between the first and the second characteristic points on the image, a distance D2 between the second and the third characteristic points on the image, a distance D3 between the third and the fourth characteristic points on the image, and a distance D4 between the fourth and the first characteristic points on the image are calculated respectively. The calculation of the distances D1 to D4 is performed only for the reference frame image but also for each of the frame images after the reference frame, in which the first to the fourth characteristic points are tracked.

A characteristic point historical memory 52 stores the distances D1 to D4 of the latest k frames arranged in time sequence (k is an integer of two or larger as described above). For instance, just after the distances D1 to D4 are specified in the n-th frame image, the distances D1 to D4 of at least the (n−k+1)th to the n-th frame images are stored in the characteristic point historical memory 52. A set of the distances D1 to D4 stored in the characteristic point historical memory 52 is referred to as “characteristic point sequential information” as a generic name. The characteristic point sequential information is output to the lens position control portion 54.

An AF evaluation portion 53 is similar to the AF evaluation portion shown in FIG. 4, and it calculates the AF score of each of the frame images. The lens position control portion 54 generates a lens position control signal for controlling the lens position based on the characteristic point sequential information and the AF score from the AF evaluation portion 53, so as to output the lens position control signal to the driver 34 (see FIG. 2) for controlling the lens position.

The Example 3 is intended to show the case where the focus control portion 20b performs the continuous AF.

In the Example 3, the action until the focus state of the main subject is realized once, i.e., the action of the continuous AF until the timing T1 described above in the Example 1 is the same as the Example 1. It is supposed that the searching process of the focal lens position is completed in the reference frame so that the lens position is set to the focal lens position. In this case, the reference frame image corresponds to the frame image at the timing T1 (the frame image 201 in the Example 1 shown in FIG. 6A).

Then, similarly to the Example 1, it is supposed that the subject distance of the main subject increases in the period from the timing T1 to the timing T2. FIG. 15 illustrates a frame image 411 at the timing T2, and four points in the frame image 411 indicate the first to the fourth characteristic points in the frame image 411.

If a movement of the main subject is fast, it is difficult to make the lens position follow the focal lens position. This example is on the assumption of that state, and it is supposed that the lens position is not changed in the period from the timing T1 to the timing T2. Then, the AF score at the timing T2 decreases rapidly from the timing T1. The lens position control portion 54 shown in FIG. 13 detects this decrease in the AF score and decides that the focus state of the main subject is lost. Therefore, the lens position control portion 54 performs the searching process again after the timing T2. On this occasion, the lens position control portion 54 determines the moving direction of the focus lens 31 when the searching process is started again (in other words, the searching direction of the focal lens position) based on the characteristic point sequential information.

The characteristic point sequential information for determining the moving direction includes the distances D1 to D4 of the frame images 401 and 411 at the timings T1 and T2. The lens position control portion 54 compares the corresponding distances with each other between the frame images so as to decide a change in size of the main subject between the timings T1 and T2. More specifically, the lens position control portion 54 detects a variation quantity and its direction between the timings T1 and T2 of each of the distances D1 to D4, so as to decide the change in size of the main subject between the timings T1 and T2 based on a result of the detection. Actually, the change in size of the main subject can be decided based on an average of variation quantities of the distances D1 to D4, for instance.

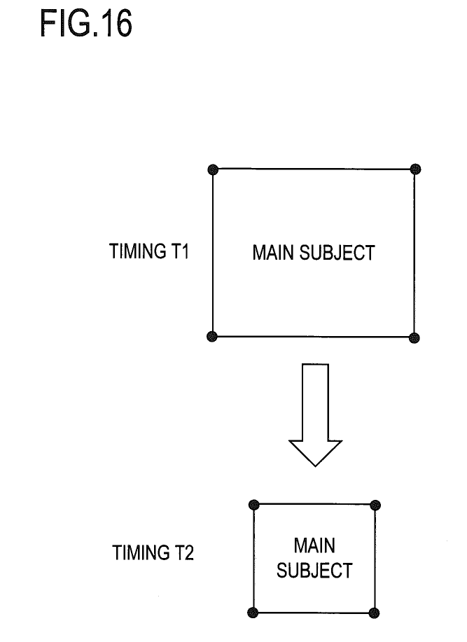

The first to the fourth characteristic points are points indicating characteristic parts of the main subject, and a size of the main subject is substantially proportional to a size of a figure formed by the first to the fourth characteristic points as shown in FIG. 16. Therefore; if the subject distance of the main subject increases in the period from the timing T1 to the timing T2, each of the distances D1 to D4 decreases in the period between the timings T1 and T2. If such a decrease is detected, the lens position control portion 54 decides that the subject distance has increased so that a size of the main subject on the image has decreased. Then, the lens position control portion 54 determines the moving direction of the focus lens 31 when the searching process is started again to be the infinite point direction. Therefore, after the timing T2, the focus lens 31 is moved in the infinite point direction with respect to the lens position at the timing T2 while a largest AF score is searched again (i.e., the focal lens position is searched again).

According to this example, a change in size of the main subject is detected based on a change in distance between two of a plurality of characteristic points (in other words, a relative position between two of a plurality of characteristic points), so that the same continuous AF as the Example 1 as well as the same effect as the Example 1 can be obtained.

In addition, the case where the subject distance of the main subject becomes larger at the timing T2 than at the timing T1 is exemplified in the above description. If the subject distance of the main subject becomes smaller at the timing T2 than at the timing T1, the moving direction of the focus lens 31 should be the opposite direction. More specifically, if the distances D1 to D4 increased in the period between the timings T1 and T2, the lens position control portion 54 decides that the subject distance has decreased and that a size of the main subject on the image has increased. Then, the lens position control portion 54 determines the moving direction of the focus lens 31 when the searching process is started again to be the near end direction.

A relationship between the frame images 401 and 411 shown in FIGS. 14 and 15 will be further described. The frame images 401 and 411 are, for instance, the (n−k+1)th and the n-th frame images, respectively (k is an integer of two or larger as described above). In a simple example, k is two. In this case, the above-mentioned moving direction is determined based on changes in the distances D1 to D4 between the neighboring frame images.

Of course, k may be three or larger. If k equals to three, a change in size of the main subject between the (n−2)th and the n-th frames is detected based on the distances D1 to D4 of the (n−2)th to the n-th frame images, so that the above-mentioned moving direction is decided based on a result of the detection. For instance, if the distances D1 to D4 decrease from the (n−2)th frame to the n-th frame, it is decided that a size of the main subject on the image has decreased so that the moving direction of the focus lens 31 when the searching process is started again is determined to be the infinite point direction. On the contrary, if the distances D1 to D4 increase from the (n−2)th frame to the n-th frame, it is decided that a size of the main subject on the image has increased so that the moving direction of the focus lens 31 when the searching process is started again is determined to be the near end direction.

Although the number of the characteristic points to be tracked is four, it may be any number of two or more (the same is true in Example 4 and Example 6 that will be described later). It is because two characteristic points are sufficient for detecting a size of the main subject on the image from a distance between the two characteristic points.

### Example 4

The method of the Example 3 can be applied to the single AF. Such a case will be described as Example 4 of the present invention. The Example 4 corresponds to a variation of the Example 2 similarly to the Example 3 that is a variation of the Example 1. A block diagram of a part concerned with the automatic focus control of the Example 4 is the same as shown in FIG. 13, so overlapping illustration thereof will be omitted. The main control unit 13 (see FIG. 1) according to the Example 4 includes the focus control portion 20b shown in FIG. 13. The focus control portion 20b is used as the focus control portion 20 shown in FIG. 1.

Similarly to the Example 3, the focus control portion 20b sets an AF evaluation area in each of frame images and deals with a subject in the set AF evaluation area as the main subject. Basic actions of individual portions in the focus control portion 20b are the same as those of the Example 3.

With reference to FIG. 9 in this example too, it is supposed that the frame image 301 at the timing T3 is recorded in the recording medium 16 as the first record image, and that the frame image 351 at the timing T4 is recorded in the recording medium 16 as the second record image, similarly to the Example 2. In addition, it is supposed that the frame image 311 is obtained at the timing T_{A} between the timings T3 and T4 as shown in FIG. 9.

An action of the single AF with respect to the frame image 301 is the same as in the Example 2. More specifically, before the timing T3, the lens position control portion 54 moves the focus lens 31 from the near end to the infinite point (or from the infinite point to the near end) one by one step of a predetermined movement, so that the latest AF score is obtained from the AF evaluation portion 53 in each movement. Then, the lens position that makes the AF score the maximum value within the searching range is specified as the focal lens position, and a real lens position is moved to the specified focal lens position so as to fix the lens position. The frame image 301 is obtained in this state. The reference frame image from which the first to the fourth characteristic points are extracted corresponds to the frame image 301.

Then, it is supposed that the subject distance of the main subject that was constant before the timing T3 increases in the period between the timing T3 and the timing T_{A} similarly to the Example 2 (see FIG. 9). In this case, the distances D1 to D4 must have decreased in the period between the timings T3 and T_{A}. The lens position control portion 54 takes this decrease into account so as to determine the searching range of the single AF with respect to the frame image 351.

It will be described in more detail. In the period between the timings T_{A} and T4, the focus control portion 20b performs the single AF with respect to the frame image 351 and determines the above-mentioned searching range on this occasion based on the above-mentioned characteristic point sequential information.

The characteristic point sequential information for determining the searching range includes the distances D1 to D4 with respect to the frame images 301 and 311, and the lens position control portion 54 decides a change in size of the main subject between the timings T3 and T_{A} by comparing the corresponding distances with each other between the frame images. This decision method is the same as that described in the Example 3.

The first to the fourth characteristic points are points indicating characteristic parts of the main subject, and a size of the main subject is substantially proportional to a size of a figure formed by the first to the fourth characteristic points. Therefore, if the subject distance of the main subject increases in the period from the timing T3 to the timing T_{A}, each of the distances D1 to D4 decreases in the period between the timings T3 and T_{A}. If such a decrease is detected, the lens position control portion 54 decides that the subject distance has increased so that a size of the main subject on the image has decreased. Then, the lens position control portion 54 determines the searching range of the single AF with respect to the frame image 351 to be closer to the infinite point than the current lens position similarly to the Example 2.

More specifically, when the lens position at the timing T_{A} is referred to as the lens position 315 similarly to the Example 2 (see FIG. 12), the lens position control portion 54 determines the lens position range between the lens position 315 at the timing T_{A} and the lens position 316 located closer to the infinite point than the lens position 315 to be the searching range of the single AF with respect to the frame image 351. After that, in the period between the timings T_{A} and T4, the focus lens 31 is moved from the lens position 315 in the infinite point direction to the lens position 316 one by one step of a predetermined movement so that the latest AF score is obtained from the AF evaluation portion 53 in each movement. Then, the lens position that makes the AF score the maximum value within the searching range is specified as the focal lens position, and a real lens position is moved to the specified focal lens position so as to fix the lens position. The frame image 351 shown in FIG. 9 is obtained in this state.

The lens position 316 shown in FIG. 12 that is an end point of the searching range is simply regarded as the infinite point for instance. However, it is possible to regard a lens position between the lens position 315 and the infinite point to be the lens position 316. For instance, a variation quantity of the subject distance between the timings T3 and T_{A} is estimated from comparison between the AF score of the frame image 301 and the AF score of the frame image 311 or comparison between the distances D1 to D4 in the frame image 301 and the distances D1 to D4 in the frame image 311. If it is estimated that the variation quantity is relatively small, the lens position 316 may be set between the lens position 315 and the infinite point in accordance with the estimated variation quantity.

According to this example, a change in size of the main subject is detected based on a change in distance between two of a plurality of characteristic points (in other words, a relative position between two of a plurality of characteristic points), so that the same single AF as the Example 2 can be realized and that the same effect as the Example 2 can be obtained.

In addition, the case where the subject distance of the main subject becomes larger at the timing T_{A} than at the timing T3 is exemplified in the above description. If the subject distance of the main subject becomes smaller at the timing T_{A} than at the timing T3, the searching range should be a range in the direction opposite to that described above. More specifically, if the distances D1 to D4 increase in the period between the timings T3 and T_{A}, the lens position control portion 54 decides that the subject distance has decreased and that a size of the main subject on the image has increased. Then, the lens position control portion 54 determines the searching range of the single AF with respect to the frame image 351 to be closer to the near end than the current lens position. The process after that is the same as the process described above except for the different searching ranges.

The frame image 301 at the timing T3 and the frame image 311 at the timing T_{A} handled in this example are, for instance, the (n−k+1)th and the n-th frame images (k is an integer of two or larger as described above). In a simple example, k is two. In this case, the above-mentioned searching range is determined based on changes in the distances D1 to D4 between the neighboring frame images.

Of course, k may be three or larger. If k equals to three, a change in size of the main subject between the (n−2)th and the n-th frames is detected based on the distances D1 to D4 of the (n−2)th to the n-th frame images, so that the above-mentioned searching range is decided based on a result of the detection. For instance, if the distances D1 to D4 decrease from the (n−2)th frame to the n-th frame, it is decided that a size of the main subject on the image has decreased so that the searching range of the single AF with respect to the frame image 351 is determined to be closer to the infinite point than the current lens position. On the contrary, if the distances D1 to D4 increase from the (n−2)th frame to the n-th frame, it is decided that a size of the main subject on the image has increased so that the searching range of the single AF with respect to the frame image 351 is determined to be closer to the near end than the current lens position.

Also in the case where the third record image (the fourth, the fifth, . . . record image) is further obtained and recorded after the timing T4 shown in FIG. 9, the searching range is set in the same manner as described above. More specifically, a change in size of the main subject with respect to the timing T4 is detected based on the characteristic point sequential information, so that the searching range of the single AF with respect to the third record image is determined based on a result of the detection (the same is true on the fourth, the fifth, . . . record images).

### Example 5

Next, Example 5 of the present invention will be described. Although the Examples 1 to 4 are described on the assumption that the optical zoom magnification is fixed, the Example 5 will be described on the assumption that the optical zoom magnification is changing while the useful continuous AF is performed.

The change in magnification of the optical zoom is realized by a movement of the zoom lens 30 in the optical system 35 as shown in FIG. 2. When the user makes a predetermined zoom operation with the operating unit 17, the driver 34 shown in FIG. 2 moves the zoom lens 30 under control of the main control unit 13. A focal length of the optical system 35 depends on a position of the zoom lens 30. The main control unit 13 (see FIG. 1) that controls the position of the zoom lens 30 via the driver 34 recognizes the focal length of the optical system 35.

Under the condition that a subject distance of a noted subject does not change, if the focal length of the optical system 35 is increased by the movement of the zoom lens 30, a size of an optical image of the noted subject formed on the imaging sensor 33 increases (i.e., the optical zoom magnification increases), on the contrary, if the focal length of the optical system 35 is decreased by the movement of the zoom lens 30, a size of an optical image of the noted subject formed on the imaging sensor 33 decreases (i.e., the optical zoom magnification decreases).

A block diagram of a part concerned with the automatic focus control according to the Example 5 is the same as that shown in FIG. 5. Therefore, the main control unit 13 (see FIG. 1) of the Example 5 includes the face detection portion 41 and the focus control portion 20a shown in FIG. 5. As to the Example 5, however, focal length information indicating a focal length of the optical system 35 is supplied to the lens position control portion 44 shown in FIG. 5, so that the lens position control portion 44 generates the lens position control signal based on the focal length information, the face size sequential information and the AF score.

The case where each of the frame images includes a face of a human is supposed similarly to the Example 1, and the automatic focus control according to the Example 5 will be described in more detail. As to the Example 5, the face area is included in the AF evaluation area similarly to the Example 1. Therefore, a face of a human is dealt with as the main subject, and the continuous AF is performed so that the main subject becomes in focus.

A face size to be detected by the face detection portion 41 changes not only in the case where the subject distance of the main subject has changed but also in the case where the optical zoom magnification has changed. If the optical zoom magnification has changed from the first magnification to the second magnification under the condition that the subject distance of the main subject does not change, the face size detected by the face detection portion 41 changes from the first size to the second size. On this occasion, a value obtained by dividing the second size by the first size is referred to as a “face size enlargement ratio by optical zoom”.

Now, it is supposed that the optical zoom magnification changes in the period from the timing T1 to the timing T2, and that the frame images at the timings T1 and T2 are the frame images 201 and 211 shown in FIGS. 6A and 6B, respectively. As described above, the AF evaluation areas 203 and 213 are set for the frame images 201 and 211, and the face areas 202 and 212 are extracted from the frame images 201 and 211.

The focal lengths at the timings T1 and T2 (i.e., the focal lengths when the frame images 201 and 211 are obtained) are denoted by f1 and f2, respectively. Then, the face size enlargement ratio Y_{Z} by optical zoom between the timings T1 and T2 is expressed by the equation (1) below.

Y_{Z}=f1/f2 (1)

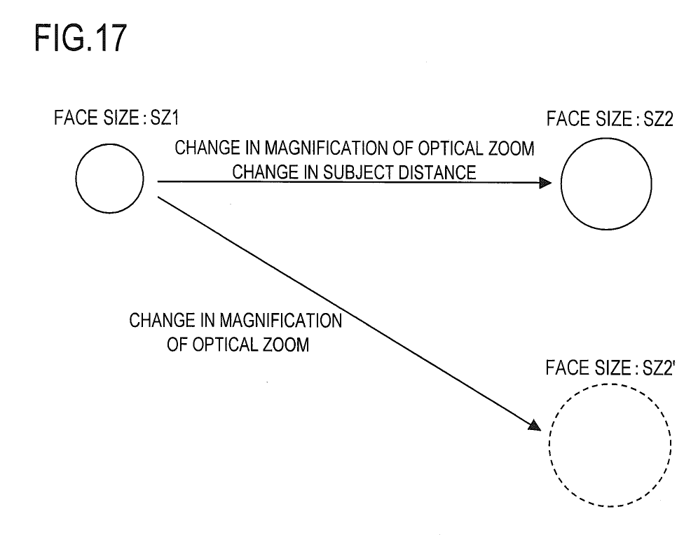

In addition, the face sizes of the face areas 202 and 212 are denoted by SZ1 and SZ2, respectively. The face sizes SZ1 and SZ2 are detected by the face detection portion 41 based on the frame images 201 and 211. The face size of the face area 212 increases or decreases with respect to the face size of the face area 202 because of a change in the optical zoom magnification and a change in the subject distance in the period between the timings T1 and T2. A face size of the face area in a virtual frame image that would be obtained by exposure at the timing T2 if the subject distance does not change in the period between the timings T1 and T2 is denoted by SZ2′. The face size SZ2′ is expressed by the equation (2) below. FIG. 17 illustrates a relationship among the face sizes SZ1, SZ2 and SZ2′.

SZ2′=SZ1×Y_{Z} (2)

An enlargement ratio of the face size resulted from only a change in subject distance, i.e., an enlargement ratio of the face size without an influence of a change in the optical zoom magnification can be obtained from a ratio between the face size SZ2 detected by the face detection portion 41 and a face size SZ2′ estimated from a change in the focal length. The enlargement ratio of the face size expressed by the ratio is denoted by Y_{D}. The enlargement ratio Y_{D} can be determined by the equation (3) below.

$$\begin{matrix}{Y}_{D} = SZ {2}^{′} / SZ 2 \\ = ( SZ 1 \times {Y}_{Z} ) / SZ 2 \\ = \{ SZ 1 \times ( f 1 / f 2 ) \} / SZ 2\end{matrix} \qquad ( 3 )$$

The lens position control portion 44 determines the enlargement ratio Y_{D} between the timings T1 and T2 based on the face size sequential information and the focal length information, so as to adjust the lens position in accordance with the enlargement ratio Y_{D}. More specifically, the following operation is performed.

It is supposed that the main subject is in focus at the timing T1 by the continuous AF that had been performed before the timing T1 (the searching process described above in the Example 1), and that the lens position at the timing T1 matches the focal lens position. It is also supposed that at least one of the subject distance of the main subject and the optical zoom magnification has changed in the period from the timing T1 to the timing T2. If the movement of the main subject is fast, it is difficult to make the lens position follow the focal lens position. This example is on the assumption of that state, and it is supposed that the lens position is not changed in the period from the timing T1 to the timing T2. Then, the AF score at the timing T2 decreases rapidly from the timing T1. The lens position control portion 44 detects this decrease in the AF score and decides that the focus state of the main subject is lost so as to performs the searching process again after the timing T2.

On this occasion, the lens position control portion 44 determines the moving direction of the focus lens 31 when the searching process is started again (in other words, the searching direction of the focal lens position) based on the face size sequential information and the focal length information. More specifically, the enlargement ratio Y_{D} between the timings T1 and T2 is determined in accordance with the equation (3) based on the face sizes SZ1 and SZ2 of the face areas 201 and 211 included in the face size sequential information and the focal lengths f1 and f2 at the timings T1 and T2 included in the focal length information. Then, the change in the subject distance of the main subject in the period between the timings T1 and T2 is estimated (in other words, the moving direction of the main subject viewed from the imaging apparatus 1 is estimated) based on the enlargement ratio Y_{D}.

If the enlargement ratio Y_{D} is larger than one, it is estimated that the subject distance of the main subject has decreased, so that the moving direction of the focus lens 31 when the searching process is started again is determined to be the near end direction. In this case, after the timing T2, the focus lens 31 is moved in the near end direction while the focal lens position is searched again with respect to the lens position at the timing T2.

On the contrary, if the enlargement ratio Y_{D} is smaller than one, it is decided that the subject distance of the main subject has increased, so that the moving direction of the focus lens 31 when the searching process is started again is determined to be the infinite point direction. In this case, after the timing T2, the focus lens 31 is moved in the infinite point direction while the focal lens position is searched again with respect to the lens position at the timing T2.

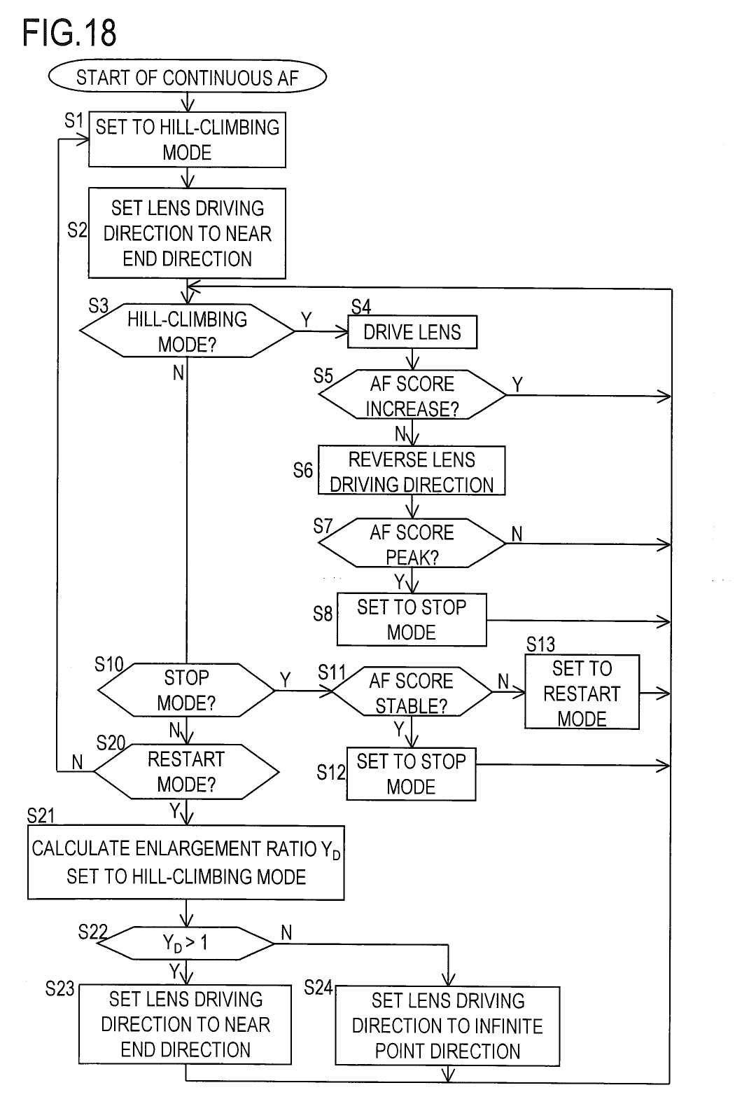

A flow of an action of the continuous AF according to the Example 5 will be described with reference to FIG. 18. FIG. 18 is an operating flowchart of the continuous AF according to the Example 5. During the action of the continuous AF, with respect to each of the frame images obtained sequentially, the face detection portion 41 performs the face detection process, and the AF evaluation portion 43 performs the AF score calculation process, so that the face size sequential information is updated sequentially based on the face detection process.

When the continuous AF is started as the automatic focus control, the AF operating mode is set to a hill-climbing mode first in the step S1. The lens driving direction (direction in which the focus lens 31 is moved) is set to the near end direction in the next step S2, and then the process goes to the step S3. The AF operating mode defines a state of the automatic focus control. The AF operating mode is set to any one of the hill-climbing mode, a stop mode and restart mode. If the AF operating mode is set to the hill-climbing mode, the focus lens 31 is moved (i.e., the lens position is adjusted) based on the hill-climbing method. If the AF operating mode is set to the stop mode, the focus lens 31 is stopped. The restart mode is a mode for resetting the AF operating mode from the stop mode to the hill-climbing mode, and the focus lens 31 is stopped also when the AF operating mode is set to the restart mode.

In the step S3, it is checked whether or not the AF operating mode is the hill-climbing mode. If the AF operating mode is the hill-climbing mode, the process goes to the step S4. Otherwise, the process goes to the step S10. In the step S4, the focus lens 31 is driven in the lens driving direction that is set at present (i.e., the lens position is moved in the lens driving direction by a predetermined movement). After that, the process goes to the step S5. The drive of the focus lens 31 is performed by the lens position control signal from the lens position control portion 44 as described above.

In the step S5, the lens position control portion 44 compares the AF scores obtained before and after the lens drive in the step S4, so as to decide whether or not the AF score obtained after the lens drive has increased compared with the AF score obtained before the lens drive. If it is decided that the AF score has increased, the process goes back to the step S3. On the contrary, if it is decided that the AF score has decreased, the lens driving direction is reversed in the step S6 and then the process goes to the step S7. For instance, if a decrease in the AF score is observed in the state where the lens driving direction is set to the near end direction, the lens driving direction is set to the infinite point direction in the step S6.

In the step S7, the lens position control portion 44 decides whether or not a lens position that makes the AF score a local maximum value is found. If the AF score increases and then decreases when the lens position is moved in a constant direction, the AF score has a local maximum value during the movement process. If such a local maximum value is observed, the process goes from the step S7 to the step S8, where the position of the focus lens 31 is stopped at the position that makes the AF score a local maximum value (i.e., the focal lens position) while the AF operating mode is set to the stop mode. After that, the process goes back to the step S3. If the lens position that makes the AF score a local maximum value is not found in the step S7, the process goes from the step S7 back to the step S3 directly.

In the step S10, it is checked whether or not the AF operating mode is the stop mode. If the AF operating mode is the stop mode, the process goes to the step S11. Otherwise, the process goes to the step S20. In the stop mode, the lens position control portion 44 monitors whether or not the AF score is stable based on the AF score sent from the AF evaluation portion 43 in series. If the AF score changes rapidly, it is decided that the AF score is not stable. Otherwise, it is decided that the AF score is stable. For instance, if the AF score decreases by a predetermined value or larger per unit time, it is decided that the AF score is not stable.

If it is decided that the AF score is stable in the step S11, the AF operating mode is set to the stop mode in the step S12, and the process goes back to the step S3. If it is decided that the AF score is not stable in the step S11, the AF operating mode is set to the restart mode in the step S13, and the process goes back to the step S3.

In the step S20, it is checked whether or not the AF operating mode is the restart mode. If the AF operating mode is the restart mode, the process goes to the step S21. Otherwise, the process goes to the step S1. In the step S21, the lens position control portion 44 calculates the enlargement ratio Y_{D} based on the face size sequential information and the focal length information in accordance with the calculation method described above, and sets the AF operating mode to the hill-climbing mode. After that, the lens position control portion 44 compares the calculated enlargement ratio Y_{D} with one in the step S22. If the enlargement ratio Y_{D} is larger than one, it is decided that the subject distance of the main subject has decreased. Then, the lens driving direction is set to the near end direction in the step S23, and the process goes back to the step S3. On the contrary, if the enlargement ratio Y_{D} is smaller than one, it is decided that the subject distance of the main subject has increased. Then, the lens driving direction is set to the infinite point direction in the step S24, and the process goes back to the step S3. Thus, the focal lens position is searched again corresponding to a change in the subject distance of the main subject.

When the continuous AF is performed as described above, the continuous AF can be stabilized, and a focusing speed can be improved similarly to the Example 1. In addition, the movement of the focal lens position can be controlled based on a result of the precise estimation of the moving direction of the main subject even if the optical zoom magnification is changing. Therefore, the continuous AF is further stabilized.

### Example 6

It is possible to combine the Example 5 with the Example 3, so that the same effect as the Example 5 can be obtained. The example according to this combination will be described as Example 6. A block diagram of a part concerned with the automatic focus control of the Example 6 is the same as shown in FIG. 13. Therefore, the main control unit 13 (see FIG. 1) according to the Example 6 includes the focus control portion 20b shown in FIG. 13. In the Example 6, however, the focal length information indicating the focal length of the optical system 35 is supplied to the lens position control portion 54 shown in FIG. 13, so that the lens position control portion 54 generates the lens position control signal based on the focal length information, the characteristic point sequential information and the AF score.

In the Example 6 too, the focus control portion 20b performs the continuous AF. It is supposed that the frame images at the timings T1 and T2 are frame images 401 and 411 shown in FIGS. 14 and 15, respectively. The action until the focus state of the main subject is realized once, i.e., the action of the continuous AF until the timing T1 is the same as described in the Example 1.

More specifically, it is supposed that the main subject is in focus at the timing T1 by the continuous AF that had been performed before the timing T1 (the searching process described above in the Example 1), and that the lens position at the timing T1 matches the focal lens position. It is also supposed that at least one of the subject distance of the main subject and the optical zoom magnification has changed in the period from the timing T1 to the timing T2. If the movement of the main subject is fast, it is difficult to make the lens position follow the focal lens position. This example is on the assumption of that state, and it is supposed that the lens position is not changed in the period from the timing T1 to the timing T2. Then, the AF score at the timing T2 decreases rapidly from the timing T1. The lens position control portion 54 detects this decrease in the AF score and decides that the focus state of the main subject is lost so as to performs the searching process again after the timing T2.

On this occasion, the lens position control portion 54 determines the moving direction of the focus lens 31 when the searching process is started again (in other words, the searching direction of the focal lens position) based on the characteristic point sequential information and the focal length information. The characteristic point sequential information includes data of the distances D1 to D4 calculated for each of the frame images 401 and 402, and the focal length information includes data of the focal length when the frame images 401 and 402 are obtained.

More specifically, for instance, a lens position control portion 54 estimates an average value D_{AVE1} of the distances D1 to D4 about the frame image 401 as a size of the main subject in the frame image 401 and estimates an average value D_{AVE2} of the distances D1 to D4 about the frame image 411 as a size of the main subject in the frame image 411. Then, the estimated values D_{AVE1} and D_{AVE2} of the size of the main subject in the frame images 401 and 411 are assigned respectively to SZ1 and SZ2 in the above equation (3), and the focal length when the frame images 401 and 402 are obtained are assigned respectively to f1 and f2 in the above equation (3), so that a value Y_{D} in the left-hand side of the equation (3) is determined. The value Y_{D} determined here indicates the enlargement ratio of a size of the main subject resulted from only a change in the subject distance, i.e., the enlargement ratio of a size of the main subject from which an influence of the change in the optical zoom magnification is eliminated.

The lens position control portion 54 estimates a change in the subject distance of the main subject in the period between the timings T1 and T2 from the determined enlargement ratio Y_{D} (in other words, it estimates the moving direction of the main subject viewed from the imaging apparatus 1). Then, the lens position control portion 54 determines the moving direction of the focus lens 31 for searching the focal lens position again based on a result of the estimation.

More specifically, if the enlargement ratio Y_{D} is larger than one, it is decided that the subject distance of the main subject has decreased so that the moving direction of the focus lens 31 when the searching process is started again is determined to be the near end direction. In this case, after the timing T2, the focus lens 31 is moved in the near end direction with respect to the lens position at the timing T2 while the focal lens position is searched again.

On the contrary, if the enlargement ratio Y_{D} is smaller than one, it is decided that the subject distance of the main subject has increased. Then, the moving direction of the focus lens 31 when the searching process is started again is determined to be the infinite point direction. In this case, after the timing T2, the focus lens 31 is moved in the infinite point direction with respect to the lens position at the timing T2 while the focal lens position is searched again.

### Example 7

In each of the examples described above, the imaging unit 11 is provided with the focus lens 31, and a position of the focus lens 31 is changed with respect to the fixed imaging sensor 33 so that the focal point is adjusted. Thus, the focus state of the main subject is realized. However, this focus state may be realized by moving the imaging sensor 33. More specifically, it is possible to adopt another structure in which a position of the imaging sensor 33 instead of the focus lens 31 is changeable by the driver 34, and the focal point is adjusted by changing a relative position between the imaging sensor 33 and a fixed lens (not shown) in the optical system 35 via a drive of the imaging sensor 33. Thus, the focus state of the main subject is realized. The example in which the focal point is adjusted by moving the imaging sensor 33 will be described as Example 7.

If the focus lens 31 is driven like the case of the Example 1, a distance between the focus lens 31 and the imaging sensor 33 is adjusted by moving the focus lens 31. Therefore, the distance is set to an optimal distance so that the focus state of the main subject is realized. In contrast, if the imaging sensor 33 is driven, a distance between the above-mentioned fixed lens and the imaging sensor 33 is adjusted by moving the imaging sensor 33. Therefore, the distance is set to an optimal distance so that the focus state of the main subject is realized. The above-mentioned fixed lens is a lens that is fixedly located in the optical system 35 for forming an optical image of the subject on the imaging sensor 33. Considering that a position of the focus lens 31 is normally fixed, the normally fixed focus lens 31 is a type of the fixed lens.

Even if the moving object that is moved for setting the above-mentioned distance to an optimal distance is the imaging sensor 33, all the techniques described in the Example 1 to the Example 6 can be applied to the Example 7. Of course, the moving object is different between the Example 1 to the Example 6 and the Example 7. Therefore, when a matter described in the Example 1 to the Example 6 is applied to the Example 7, an appropriate translation should be performed as necessity.

For convenience sake, a position of the imaging sensor 33 is referred to as a sensor position, and a position of the imaging sensor 33 when the main subject is in focus is referred to as a focal sensor position. In the Example 7, the imaging sensor 33 can be moved along the optical axis direction of the optical system 35, and the movable range of the imaging sensor 33 is a range between a predetermined near end and a predetermined infinite point. When the imaging sensor 33 is positioned at the near end, the subject distance of the subject in focus becomes minimum. When the imaging sensor 33 is positioned at the infinite point, the subject distance of the subject in focus becomes maximum. Then, as the imaging sensor 33 moves from the near end to the infinite point, the subject distance of the subject in focus increases. However, positions of the near end and the infinite point in the movable range of the imaging sensor 33 described in the Example 7 are naturally different from those of the focus lens 31 described above.

When the matter described in the Example 1 to the Example 6 is applied to the Example 7, the focus lens 31, the lens position and the focal lens position described in the Example 1 to Example 6 should be translated respectively into the imaging sensor 33, the sensor position and the focal sensor position as necessity.

If the continuous AF is performed, a position of the imaging sensor 33 is moved in the near end direction or in the infinite point direction one by one step of a predetermined movement while a maximum value of the AF score is searched so that the focal sensor position is searched. Similarly to the process for searching the focal lens position, the process for searching the focal sensor position is also referred to as the searching process. If the focus state is lost after it is obtained once, the searching process is performed again. On this occasion, the moving direction of the imaging sensor 33 when the searching process is started again (in other words, the searching direction of the focal sensor position) is determined based on the face size sequential information, based on the characteristic point sequential information, based on the face size sequential information and the focal length information, or based on the characteristic point sequential information and the focal length information, in accordance with the method described in the Example 1, the Example 3, the Example 5 or the Example 6.

More specifically, if a decrease in size of the main subject on the image is detected before the searching process is performed again (or if it is decided that the subject distance of the main subject has increased), the moving direction of the imaging sensor 33 when the searching process is started again is determined to be the infinite point direction. On the contrary, if an increase in size of the main subject on the image is detected before the searching process is performed again (or if it is decided that the subject distance of the main subject has decreased), the moving direction of the imaging sensor 33 when the searching process is started again is determined to be the near end direction.

If the second searching process is performed after the first searching process is performed in the single AF, the searching range of the focal sensor position when the second searching process is performed should be determined based on the face size sequential information or the characteristic point sequential information in accordance with the method described in the Example 2 or the Example 4.

More specifically, if a decrease in size of the main subject on the image is detected before the second searching process is performed (or if it is decided that the subject distance of the main subject has increased), the position range closer to the infinite point than the focal sensor position obtained by the first searching process is determined to be the searching range of the focal sensor position when the second searching process is performed. On the contrary, if an increase in size of the main subject on the image is detected before the second searching process is performed (or if it is decided that the subject distance of the main subject has decreased), the position range closer to the near end than the focal sensor position obtained by the first searching process is determined to be the searching range of the focal sensor position when the second searching process is performed.

Note that the focus control portion according to the Example 7 is made up of the focus control portion 20a shown in FIG. 5 or the focus control portion 20b shown in FIG. 13. In the Example 7, the lens position-control portion 44 or 55 shown in FIG. 5 or 13 works as the sensor position control portion, and the sensor position control portion outputs the sensor position control signal for controlling the sensor position to the driver 34 so that the searching process of the focal sensor position can be realized. In addition, driving of the imaging sensor 33 can be realized by an actuator, a piezoelement or the like. The same is true on the case where the focus lens 31 is driven.

### Variations

The specific values shown in the above description are merely examples, which can be modified variously as a matter of course. As variations or annotations of the embodiment described above, Note 1 to Note 3 will be described below. The contents of the individual notes can be combined arbitrarily as long as no contradiction arises.

Note 1: As to the Example 1, the Example 2 and the Example 5, a result of the face detection performed by the face detection portion 41 shown in FIG. 5 is not always correct. If a direction of the face changes or if another object comes in front of the face, reliability of the face detection may be deteriorated. The reliability of the face detection is expressed by a value indicating likelihood of being a face of the noted area in the face detection portion 41. If it is decided that the reliability of the face detection is low based on the value, it is preferable not to perform the setting of the moving direction described in the Example 1 or the Example 5 and the setting of the searching range described in the Example 2. Thus, it can be prevented that a face detection error causes a slow focusing speed.

Note 2: As to the Example 1, the Example 2 and the Example 5, the face detection portion 41 is disposed in the imaging apparatus 1, and an object to be detected in each of the frame images (a specific type of object) is a face of a human. However, the present invention is not limited to this structure. It is possible to deal with a specific type of object other than a face as the object to be detected in each of the frame images (if the face detection portion 41 is used, the specific type of object is a face of a human). For instance, the object to be detected can be a vehicle. Detection of an object other than a face can be also realized by using a known method (e.g., a pattern matching method).

Note 3: The imaging apparatus 1 shown in FIG. 1 can be realized by hardware, or a combination of hardware and software. In particular, the functions of the individual portions shown in FIGS. 5 and 13 can be realized by hardware, software, or a combination of hardware and software. If the imaging apparatus 1 is structured by using software, a block diagram of a part that is realized by software represents a functional block diagram of the part.

What is claimed is:

1. An imaging apparatus comprising:
an imaging sensor for performing photoelectric conversion of incident light; and
a focus control portion for adjusting a focal point based on an image signal obtained by the photoelectric conversion performed by the imaging sensor, wherein
the focus control portion includes a change detecting portion for detecting a change in size of a specific subject in a moving image based on the image signal, and adjusts the focal point so that the specific subject becomes in focus with the change taken into account.

2. The imaging apparatus according to claim 1, wherein
the light enters the imaging sensor through a focus lens for adjusting the focal point,
the imaging apparatus further includes a drive unit for driving the focus lens, and
the focus control portion adjusts the focal point by controlling a lens position of the focus lens using the drive unit based on the image signal, and controls the lens position based on the change in size of the specific subject so that the specific subject becomes in focus.

3. The imaging apparatus according to claim 2, wherein
the lens position when the specific subject is in focus is referred to as a focal lens position,
the focus control portion realizes a focus state of the specific subject by moving the focus lens in a near end direction or in an infinite point direction while performing a searching process for searching the focal lens position, and
when the searching process is performed again after the focus state of the specific subject is once realized, the focus control portion determines a moving direction of the focus lens when the searching process is started again based on the change in size of the specific subject.

4. The imaging apparatus according to claim 3, wherein
when a decrease in the size is detected before the searching process is performed again, the focus control portion determines the moving direction when the searching process is started again to be the infinite point direction, and
when an increase in the size is detected before the searching process is performed again, the focus control portion determines the moving direction when the searching process is started again to be the near end direction.

5. The imaging apparatus according to claim 2, wherein
the lens position when the specific subject is in focus is referred to as a focal lens position,
the focus control portion realizes a focus state of the specific subject by moving the focus lens in a near end direction or in an infinite point direction while performing a searching process for searching the focal lens position, and
when the searching process is performed again after the focus state of the specific subject is once realized, the focus control portion sets a searching range of the focal lens position when the searching process is performed again based on the change in size of the specific subject.

6. The imaging apparatus according to claim 5, wherein
when a decrease in the size is detected before the searching process is performed again, the focus control portion sets a lens position range closer to the infinite point than the focal lens position obtained by a previous searching process to be the searching range, and
when an increase in the size is detected before the searching process is performed again, the focus control portion sets a lens position range closer to the near end than the focal lens position obtained by a previous searching process to be the searching range.

7. The imaging apparatus according to claim 2, further comprising a zoom lens for realizing an optical zoom for changing a size of an optical image formed on the imaging sensor, wherein
the focus control portion controls the lens position based on the change in size of the specific subject in the moving image and a change in magnification of the optical zoom in a period for obtaining the moving image.

8. The imaging apparatus according to claim 7, wherein
the lens position when the specific subject is in focus is referred to as a focal lens position,
the focus control portion realizes a focus state of the specific subject by moving the focus lens in a near end direction or in an infinite point direction while performing a searching process for searching the focal lens position, and
when the searching process is performed again after the focus state of the specific subject is once realized, the focus control portion determines a moving direction of the focus lens when the searching process is started again based on the change in size of the specific subject and the change in magnification of the optical zoom.

9. The imaging apparatus according to claim 8, wherein
the change detecting portion estimates a change in distance between the specific subject and the imaging apparatus in real space based on the change in size of the specific subject and the change in magnification of the optical zoom,
if the estimated change before the searching process is performed again indicates an increase of the distance, the focus control portion determines the moving direction when the searching process is started again to be the infinite point direction, and
if the estimated change before the searching process is performed again indicates a decrease of the distance, the focus control portion determines the moving direction when the searching process is started again to be the near end direction.

10. The imaging apparatus according to claim 1, wherein
the focus control portion adjusts the focal point by driving and controlling a position of the imaging sensor based on the image signal, and controls the position of the imaging sensor based on the change in size of the specific subject so that the specific subject becomes in focus.

11. The imaging apparatus according to claim 1, further comprising an object detecting portion for detecting a specific type of object as the specific subject based on the image signal from each of frame images constituting the moving image, wherein
the change detecting portion detects the change in size of the specific subject based on a result of the detection performed by the object detecting portion.

12. The imaging apparatus according to claim 1, further comprising a characteristic point detecting portion for extracting a plurality of characteristic points of the specific subject from a reference frame image in the moving image so as to detect positions of the plurality of characteristic points in each of frame images constituting the moving image, wherein
the change detecting portion detects the change in size of the specific subject based on a change in relative position between the plurality of characteristic points between different frame images.

13. The imaging apparatus according to claim 11, wherein the specific type of object includes a face of a human.

14. An automatic focus control method for adjusting a focal point based on an image signal from an imaging sensor for performing photoelectric conversion of incident light, the method comprising the steps of
detecting a change in size of a specific subject in a moving image based on the image signal; and
adjusting the focal point so that the specific subject becomes in focus with the change taken into account.
